(19) United States
(12) Patent Application Publication
(10) Pub. No.: US 2026/0102921 A1
(43) Pub. Date: Apr. 16, 2026

(54) Automated Cosmetic Application System

(71) Applicant: Glam Pond, Inc., Dover, DE (US)

(72) Inventors: Alicia Angel, New York, NY (US); Stephanie R. Berry, Hinesville, GA (US); Samuel Mamo, Uniondale, NY (US); Milan Keseana Scott, Severn, MD (US)

(21) Appl. No.: 19/339,263

(22) Filed: Sep. 24, 2025

Related U.S. Application Data
(60) Provisional application No. 63/698,209, filed on Sep. 24, 2024.

(51) Int. Cl. B25J 9/16; A47C 1/11; A47C 31/12; B25J 11/00; B25J 19/02

(52) U.S. Cl. CPC B25J 9/1697; A47C 1/11; A47C 31/126; B25J 9/163; B25J 11/008; B25J 19/023

(57) ABSTRACT

An automated cosmetic application system comprising a robotics component, one or more cosmetic applicators, a computer vision system, and a facing mapping module. The system is configured to capture real-time facial landmark data, generate a personalized three-dimensional facial map, and control a robotic applicator to directly apply makeup in accordance with user preferences or pre-programmed makeup styles. The automated cosmetic application system facilitates efficient, consistent, and customizable cosmetic application, and reduces manual effort, particularly for users with limited mobility or limited makeup application experience. The system utilizes also generates custom application masks using a 3D printing system.

### CROSS-REFERENCE TO RELATED APPLICATIONS

This application claims priority from U.S. Provisional Application 63/698,209, filed Sep. 24, 2024.

### FIELD OF THE INVENTION

An automated cosmetic application system which utilizes artificial intelligence (AI), augmented reality (AR), facial mapping, computer vision, robotics trained to mimic makeup artist techniques, 3D printing of cosmetic transfer masks, and robotic application of custom make-up and other cosmetic products, as well as to cosmetic transfer masks manufactured by the automated cosmetic application system.

### BACKGROUND OF THE INVENTION

Makeup users typically spend an average of from about 20 to about 60 minutes daily applying cosmetic products to their own faces. To have makeup applied by a professional makeup artist can average from about 30 to about 60 minutes, and can be quite expensive. Learning to apply makeup using new techniques and attempting new looks requires even more time. The self-application of makeup can be a wasteful amount of valuable time and energy that the user could spend on tasks that the user deems more important to their daily life.

Indeed, conventional cosmetic application remains a highly manual process, often requiring significant time, effort, and skill to achieve consistent and aesthetically pleasing results. This process can pose challenges to individuals with physical disabilities, limited dexterity, and/or visual impairments, as well as for users who are unfamiliar with proper application techniques or lack the necessary time for daily makeup routines. As a result, people with disabilities, such as neuromuscular disease, have limited ability to self-apply cosmetics, including makeup, and limited access to wearing cosmetics unless they can afford the cost of having a professional makeup artist apply the makeup or other cosmetic products.

Existing automated or semi-automated cosmetic application systems currently on the market have demonstrated limited versatility, often offering the most basic functions and/or requiring complex user interaction. These cosmetic application systems typically are not configured to accommodate the unique facial contours of each individual user, and such limitations lead to inconsistent results. Further, known solutions frequently lack effective personalization options, fail to account for long-term changes in a user's facial geometry, and/or do not provide sanitary methods for multi-user environments. Moreover, in commercial or multi-user settings such as salons, aesthetic kiosks, and therapeutic care facilities, hygiene and user safety can be lacking which is a significant concern. Conventional reusable devices may be difficult to sanitize or lack disposable components to prevent cross-contamination.

### PRIOR ART

The prior art discloses cosmetic application machines which have had limited success, as well as generic transfer masks. U.S. Pat. No. 8,464,732 B2 to Wong discloses a facial make-up application machine which includes a base, a robot, a cosmetic provider, and a control device, the control device configured to control the robot to move the cosmetic provider to a make-up application position to spray or apply cosmetic materials to a contour corresponding to a human face.

U.S. Patent Application Publication 2023/0147029 A1 to Whitelaw relates to a system and method for automated makeup application, allowing a user to select and apply desired makeup styles to the user's face. The system includes a computer application with a graphical user interface which allows selection of a look from a plurality of preconfigured looks. A camera coupled with a robotic arm records a face map and color coding, sends that data to be stored on a virtual server database, and the system calculates the formula quantity from appropriate formula cartridges which is released into reservoirs and onto a robotic arm's head. An airbrush compressor mixes the formula and releases one of several airbrush nozzles to start spraying the user's face with the formula.

There are significant drawbacks to both Whitelaw and Wong which both only use airbrushed makeup as an application method, which usually results in overspray and is not a preferred method that most professional makeup artists use because airbrushing can look flat or mask-like. It also is difficult to layer other cosmetic products onto an airbrushed layer and only works with specialized thin formulations, thereby limiting artistry and product variety. Neither Whitelaw nor Wong '732 use brushes or sponges as applicators. Further, neither Whitelaw nor Wong '732 utilizes a chair with a head stabilizer that does not obstruct any areas of the user's face. Wong '732 also does not propose an adequate mechanism for long-term changes in facial geometry. And, neither White or Wong '732 include a 3D printing system for generating a cosmetic application transfer mask.

U.S. Pat. No. 9,607,347 B1 to Li relates to a system and method of applying cosmetics using an incoherent light projector shining light on the face, capturing reflected light using a camera and the projector and a structured light depth processor to generate a depth image output. Li is deficient in that it uses structured-light and a camera to build a 3D depth map and match facial features to motion trajectories for robotic application. The system of the present invention uses a more advanced AI mapping technique with biometric remapping over time that allows re-calibration of a user's profile as the user's facial structure changes. Li also does not provide a means for generating a cosmetic application transfer mask.

U.S. Patent Application Publication 2016/0000208 A1 to Wong provides a makeup application component including a three-dimensional mask, a transfer layer, and a pigment layer, the mask configured to correspond to the surface curve of a user's face. The transfer layer is provided with a first surface and a second surface that are opposite each other, the first surface clinging to the 3D mask while the pigment layer is attached to the second surface. One significant drawback to Wong '208 is that the pigment is pre-applied to a 3D mask and transferred to the skin in bulk. It is essentially a fixed, “pre-loaded” cosmetic sheet which is not mapped to a user's individual facial features. As a result, Wong '208 cannot provide the user with a personalized mask mapped and contoured to a specific user's facial landmark.

Despite the developments of the prior art, a need certainly still exists for an automated cosmetic application system that includes using artificial intelligence, augmented reality, computer vision to capture a user's facial landmark data in real time, and a facial mapping module the processes the facial landmark data into a three-dimensional image of the user's facial features and contours. Such a system should also include a robotics component which has been trained to mimic makeup artists techniques of makeup application, including having a robotic applicator to apply a selected facial makeup style to a user's face. Further, such a robotic applicator should have, interchangeable makeup applicators including brushes, sponges, spray applicators, and airbrush applicators. Further, such a system should include a 3D printing apparatus to generate a cosmetic application transfer mask based on the three-dimensional image.

### SUMMARY OF THE INVENTION

The present subject matter is directed to an automated cosmetic application system that utilizes artificial intelligence (AI), augmented reality (AR), facial mapping, computer vision, a robotic arm applicator, and in some embodiments, a custom 3D-printed mask applicator. Both the robotic arm modality and the 3D-printed mask modality, are supported by a user interface which allows for the selection, refinement, storage, and reuse of the user's aesthetic profiles. The automated cosmetic application system further comprises a biometric user identification module to authenticate individual users, upload and store the user's preferences, and a scheduling and reminder subsystem that notifies a user when facial remapping is recommended to ensure a continued accurate fit and performance. The features offered by the inventive automated cosmetic application system allow the system to evolve alongside the user's preferences and maintain consistent results over time.

Accordingly, it is an object of the present subject matter to provide an automated cosmetic application system which incorporates facial mapping, computer vision, and user-selectable application modes to ensure precise, efficient, and customizable delivery of makeup.

It is another object of the present subject matter to provide an automated cosmetic application system which is designed to support a wide range of users, including those with limited cosmetic experience or physical ability, and streamlines the makeup application process through automation and personalization, thereby significantly reducing the time to apply facial makeup and achieving high-quality and consistent results.

It is still another object of the present subject matter to provide an automated cosmetic application system configured to initiate a facial mapping procedure of a user seated and secured in an adjustable, multi-directional headrest assembly using high-resolution imaging and computer vision algorithms to capture and process the user's unique facial geometry.

It is a yet another object of the present subject matter to provide an automated cosmetic application system adapted to present a user with an interface which allows the user to select between a robotic arm application or a custom printed mask application once the facial mapping has been completed.

It is an additional object of the present subject matter to provide an automated cosmetic application system which generates a customed printed mask, including for example, a 3D-printed mask with an inner cosmetic transfer layer, a single-layered 2D adapted with a cosmetic transfer layer, a dual-layered 2D mask having a cosmetic transfer layer, a single-layer moisture-activated cosmetic transfer mask, a single-layer, semi-rigid custom mask having eye area flaps, a single-layer semi-rigid custom mask having additional flaps for the nose bridge and/or lip area.

It also is an object of the present subject matter to provide an automated cosmetic application system comprising a plurality of preselected makeup looks, including for example, daytime, work-appropriate, evening, glam, costume (e.g. Halloween), sports team, drag queens, theater actors, and the like.

It is another object of the present subject mater to provide an automated cosmetic application system in the form of a pod, kiosk or booth environment which is situated in cosmetic retail stores, airports, hotels, salons, spas, department stores, malls, and similar locations.

It is a further object of the present subject matter to provide an automated cosmetic application system which comprises a biometric user identification module to authenticate individual users and upload and store each user's preferences.

It is yet a further object of the present subject matter to provide an automated cosmetic application system which comprises a scheduling and reminder subsystem that notifies a user when facial remapping is recommended to ensure a continued accurate fit and performance, such as a six-month period.

It is still a further object of the present subject matter to provide an automated cosmetic application system which is adaptable to evolve alongside a user's preferences and maintain consistent results over time.

It is an additional object of the present subject matter to provide an automated cosmetic application system which is hygienic and ensures user safety, including sanitizing and disposable of components to prevent cross-contamination.

It also is an object of the present invention to provide an automated cosmetic application system which significantly reduces the time and manual effort required to apply facial makeup.

It is another object of the present invention to provide an automated cosmetic application system which eliminates the guesswork involved in the manual application of cosmetic products, including blending and symmetry concerns.

These and other objects of the present subject matter are accomplished by providing a versatile and innovative automated cosmetic application system that uses AI, AR, a biometric user identification module, facial recognition, and robotic automation for cosmetic application, and additive manufacturing to generate printed personalized cosmetic application transfer masks.

### BRIEF DESCRIPTION OF DRAWINGS

FIG. 1 is a perspective view of the automated cosmetic application system of the present subject matter.

FIG. 2 is a perspective view of the automated cosmetic application system of the present subject matter within a domed area

FIG. 3 is a perspective view of the automated cosmetic system of the present subject matter situated in a pod.

FIG. 4 is a perspective view of the automated cosmetic system of the present invention illustrating the cosmetic depositing apparatus with multi-axis nozzles.

FIG. 5 is a front perspective view of one embodiment of a customized 3D-printed mask generated by the automated cosmetic application system of the present subject matter.

FIG. 6 is a rear view of one embodiment of the customized 3D-printed mask of FIG. 5 illustrating the concave interior surface.

FIG. 7 is a front view of one embodiment of a 2D single-layer custom mask having perforated/hinged flaps generated by the automated cosmetic application system of the present subject matter.

FIG. 8 is a front view of one embodiment of a dual-layer custom mask generated by the automated cosmetic application system of the present subject matter.

FIG. 9 is a front view of one embodiment of a dual-layer custom mask generated by the automated cosmetic application system of the present subject matter.

FIG. 10 is a front view of one embodiment of a single-layer moisture-activated custom mask generated by the automated cosmetic application system of the present subject matter.

FIG. 11 is a front view of one embodiment of a 2D single-layer, semi-rigid, custom mask with eye-area flaps generated by the automated cosmetic application system of the present subject matter.

FIG. 12 is a frontal view of the automated cosmetic application system of the present subject matter illustrating a formed mask being positioned onto a user's face.

FIG. 13 is a frontal view of the automated cosmetic application system of the present subject matter illustrating a formed mask being removed from a user's face.

It is to be understood that the drawings are not necessarily to scale. Rather, the drawings are merely representations, not intended to portray specific parameters of the present subject matter unless specified otherwise. The drawings are intended to depict exemplary embodiments of the present subject matter, and therefore should not be considered limiting in scope. In the drawings, like numbering represents like elements. Further, certain elements in some figures may be omitted, or not illustrated to scale, for illustrative clarity. Any cross-sectional views may be in the form of “slices,” or “near-sighted” cross-sectional views, omitting certain background lines that may otherwise be visible in a “true” cross-sectional view, for illustrative clarity. In some instances, where multiple elements are present, only a single element may be labeled or multiple elements may have the same label to indicate that the label applies to all elements of the same type.

### DESCRIPTION OF THE INVENTION

In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

As described herein, the term “robotic arm,” “robotic arm's hand,” “robotic device,” “robotic apparatus,” derivatives thereof, and similar terms may be used throughout the specification and it is to be understood that such terms are interchangeable and all refer to the robotic applicator of the present subject matter. In addition, as described herein, the terms “booth,” “application booth,” “kiosk,” “glam pod,” derivatives thereof, and similar terms may be used throughout the specification and it is to be understood that such terms are interchangeable and all refer to a physical location within which the application station of the automated cosmetic application system of the present subject matter. Further, the term “cosmetic system,” “automated system,” “application system,” “system” derivatives thereof, and similar terms may be used throughout the specification and it is to be understood that such terms are interchangeable and all refer to the automated cosmetic application system of the present subject matter

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Pursuant to the FDA, the term cosmetics is defined as “articles intended to be rubbed, poured, sprinkled, or sprayed on, introduced into, or otherwise applied to the human body . . . for cleansing, beautifying, promoting attractiveness, or altering the appearance” [FD&C Act, sec 201(i)]. Among the products included in this definition makeup for the eyes such as eye shadow, eye liner, and, facial makeup such as foundation, blush, and makeup for the lips, such as lipstick, as well as any substance intended for use as a component of a cosmetic product. Accordingly, throughout this specification, it should be understood that the term “makeup” will be considered the equivalent of the term cosmetic pursuant to the FDA definition.

It also should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present invention is directed to an automated cosmetic application system. More particularly, the invention is an automated cosmetic application system that uses artificial intelligence (AI), augmented reality (AR), computer vision to capture a user's facial features data in real time, a facial mapping module to process the facial features data into a three-dimensional image of the user's face, a robotics component, and 3D printing system. The automated cosmetic application system is adapted for both direct application of a custom makeup style onto a user's face in minutes and to generate a cosmetic application transfer mask for the user to apply the makeup style as desired.

The automated cosmetic application system of the present subject matter can be housed in an enclosed environment, such as a pod, booth or kiosk or may be presented as an open or semi-open station. The automated cosmetic application system also may be accessed by means of a mobile application. In both instances, the automated system can generate a cosmetic application transfer mask. It also will be understood by those skilled in the art that a home version of the AI-driven automated cosmetic application system of the present subject matter, or variants thereof with a robotic hand and/or cosmetic application mask 3D printers may be created when the necessary technology and expense of such a system can be provided for individual home use, and is contemplated to be within the scope of the present invention.

In one embodiment, the automated cosmetic application system is situated within an enclosed or semi-enclosed booth (hereinafter sometimes referred to as “application booth” or “booth”), which is designed to maximize user comfort, stability, and safety during automated cosmetic makeup application. The application booth comprises an ergonomically contoured seat coupled with a head support assembly, interactive controls, and integrated safety sensor modules, all housed within a closed or partially open structure. The automated cosmetic application system can be a used by anyone desirous or in need of a professional application of cosmetics.

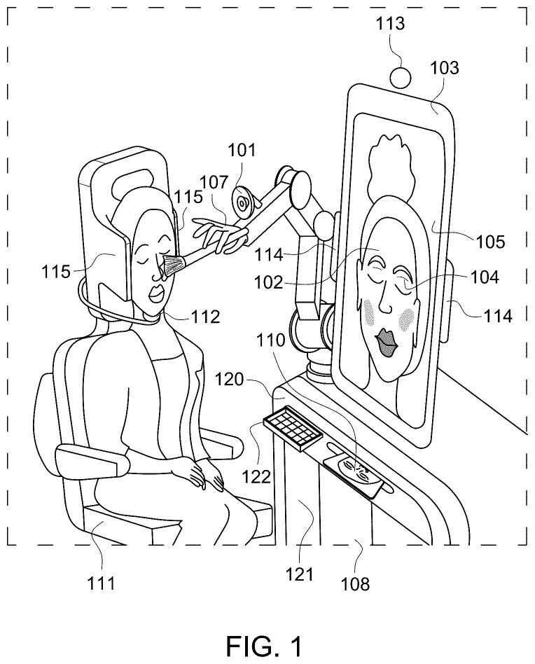

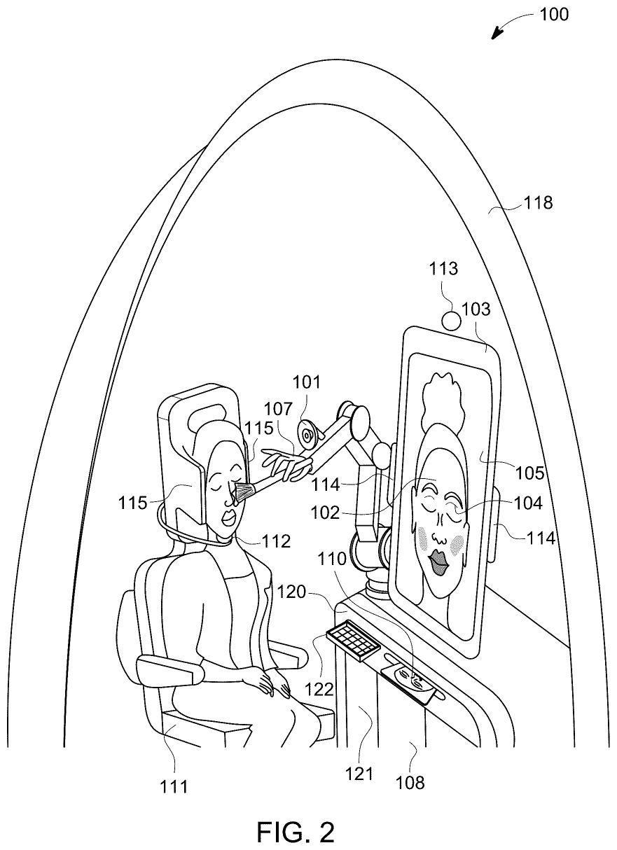

Referring to FIGS. 1 and 2, the automated cosmetic application system 100 comprises a glam station (pod, booth, open or semi-open station) comprising a chair 111 with adjustable positions for the user to sit in to for the makeup application process, an optional chin rest 112 to stabilize the user's head and/or face, a light source 113, a speaker 114 which will play commands for the user (i.e. “close your eyes, “keep your mouth closed,” “look at the point in the center of the screen”), a head stabilizer 115 which may be used in combination with the chin rest 112 or in place of the chin rest. The glam station further comprises the components necessary to capture a three-dimensional image of a user's face, including a camera 101, facial mapping software 102, cloud storage 103 for facial mapping images, the cloud storage 103 also containing preconfigured makeup style templates, a software tool 104 having a program to enable users to select, adjust, and create digital makeup looks to be applied to an on-screen 3D digital image using artificial intelligence (AI), augmented reality (AR), or a combination of both technologies, a display screen monitor 105 that displays a plurality of customizable and preconfigured digital makeup looks for the user to select and use as presented. Or the user may select and adjust the plurality of digital make looks according to their preferences, as well as the option of creating fully customizable digital makeup looks using the built-in software. The system further comprises a robotic applicator in the form of a robotic arm assembly 107 which has been taught by makeup artists to mimic the techniques of professional makeup artists and which has been configured to use a combination of soft brushes, sponges, human skin-like robotic fingers, airbrush and/or other tools that can be used to apply cosmetic products to the user's face to match the selected digital makeup look, receptacles for cosmetic product storage 120, a cosmetic mixing system 121 which is required to mix the cosmetic products to match the colors in the look selected by the user, and a tray 122 having multiple sections for holding the mixed makeup colors to be separated and accessed by the robotic applicator so it can apply each mixture to the proper areas of the face, and a sanitizing system 108 for any reusable cosmetic application tools. The sanitizing system utilizes UV-C light sterilization to disinfect tools between uses, quick cycles (e.g. under five minutes) to ensure minimal downtime, and built-in safety mechanisms to prevent accidental exposure to UV light.

The display screen monitor 105 includes a touchscreen display for easy navigation and selection of the preconfigured or customized look, typically a 10-inch to 15-inch display, having a full HD resolution or higher for clear visualization of makeup looks and a user interface which allows users to browse and select from a variety of digital makeup styles. The user interacts with the system through a graphical user interface, which may be a touchscreen, mobile app, or voice assistant. Users may select from predefined cosmetic looks or customize their preferences. Once a style is selected, the robotic arm begins the application process using the appropriate applicators and cosmetic product cartridges.

The automated cosmetic application system also comprises a 3D printer system 109 that is configured to create cosmetic application transfer mask versions of the customizable makeup styles for use at home or on the go. The 3D printer system is a high-resolution, resin-based 3D printer, the resolution being sufficient and capable of printing fine details to ensure accurate makeup masks and should have efficient printing processes to produce the masks quickly.

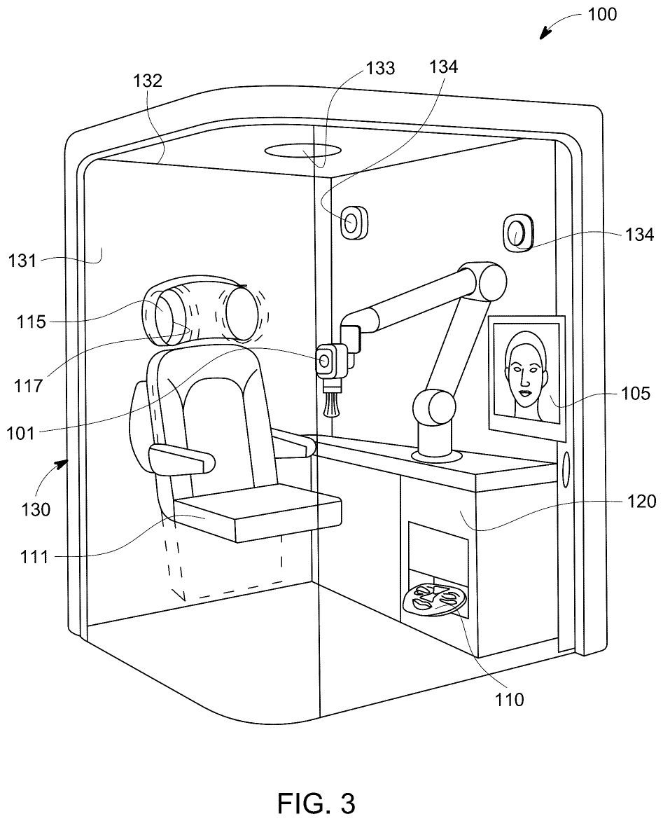

The automated system shown in FIG. 1 is an open-spaced system. In FIG. 2, the automated system is partially open, having a partial dome-like structure 118 to provide some visual privacy and environmental control. Referring now to FIG. 3, in a preferred embodiment, the automated cosmetic application system 100 is housed an enclosed or semi-enclosed application booth 130 comprising side walls 131 and a ceiling structure 132 to provide additional visual privacy and environmental control. Interior lighting 133 is provided and can be adjustable to optimal application conditions (e.g. daylight balance), and acoustic panels 134 may be included to dampen external noise. Materials for the booth enclosure may include lightweight composites or molded polymers with smooth, cleanable surfaces resistant to cosmetic contamination. The booth entrance is of sufficient width and unobstructed, thereby enabling wheelchair access and assisted seating. The automated system detects user height and posture and adjusts the robotic arm path, camera angles, and headrest position accordingly to accommodate various user body types, heights, or mobility limitations. This embodiment provides a safe, comfortable, and immersive environment for users undergoing robotic cosmetic application. The combination of head stabilization, flinch detection, and voice-activated control ensures precise results with minimal physical or cognitive effort. The booth's accessibility and ergonomic design further support adoption by a wide range of users, including individuals with physical disabilities or anxiety about mechanical interactions.

The booth further comprises an array of safety motion monitoring sensors which are configured to detect flinching, involuntary movements, or instability during operation. By way of example, such sensors may include 3D vision sensors for real-time positional tracking of the face, time-of-flight sensors for depth change detection, and headrest-embedded pressure transducers to detect force shifts. In operation, if a sudden movement is detected which exceeds a pre-calibrated threshold, the control system immediately halts robotic movement, retracts the application to a standby position, and notifies the user. The system will resume operation only upon verbal confirmation or re-stabilization of the head, thereby ensuring user safety and emotional comfort. In addition, one or more manual emergency stop controls are positioned within arm reach of the user, such as on the inner armrests, an may be illuminated for visibility in dim environments.

The ergonomically contoured seat 111 is configured to recline and support a user in a relaxed, semi-upright position. The backrest is adjustable and padded, with contoured lumbar support to minimize muscular tension. The seat comprises adjustable armrests and a footrest to promote comfort during longer sessions. Upholstery materials may include antimicrobial and hypoallergenic foam or gel padding, enclosed within wipeable cosmetically resistant coverings.

The contoured seat further comprises a memory-foam or gel-based head cradle contoured to support the occipital region of the skull. On either side of the headrest, gently compressible lateral paddles or stabilizers 117 provide minimal side-to-side restriction while accommodating natural head shapes. The cradle comprises a height-adjustable and tilt-controllable mechanism, operable via the user interface or voice command. The headrest support assembly comprises an adjustable headrest configured for multi-direction positioning, including vertical (height), longitudinal, and lateral (horizontal) adjustments. The headrest is operable to rotate or pivot to accommodate various anatomical alignments of the user's aback, cervical spine, and cranium to provide positional support during use. Adjustment of the headrest is achieved through a motorized mechanism, which may be selectively overridden by a manual control system to ensure operability in the event of motor failure or electrical control interruption. An exterior surface of the headrest includes a cushioning layer formed from a compliant material to enhance user comfort. Additionally, the surface is configured to receive a removable, single-use sanitary layer, which may be secured to the headrest by a pressure sensitive adhesive and/or hook and loop fastening. The disposable layer is intended to reduce cross-contamination and facilitate hygienic use of the apparatus across multiple users.

The headrest support assembly may be equipped with integrated pressure or proximity sensors configured to detect unintentional movement or displacement beyond a predefined tolerance. In response to such movement, the system may pause robotic operation and alert the user via audio or visual signals. One or more near-field microphones are positioned adjacent to the headrest area for optimal voice command capture. The system is programmed with a library of control phases, including initiation commands (e.g. “begin application”) preference adjustments (e.g. “less pressure,” “skip eyeliner,” and safety triggers (e.g. “pause,” and “stop now”). A feedback mechanism such as a haptic vibration or LED illumination confirms voice command reception. The automated system further may comprise a wireless audio assistant or be operable via a connected mobile application with voice relay.

The speaker system is of a high-quality audio output for clear instructions, adjustable volume to meet the demands of different environments and be pre-programmed with a set of standard commands (e.g. “close your eyes”), and should be customizable for specific instructions.

According to some embodiments, certain technical requirements are necessary to achieve the AI-generated automated cosmetic application system of the present subject matter, including a computer vision system, a facing mapping module, a robotic component, and one or more cosmetic applicators. It will be understood by those skilled in the art that following description of such technical requirements is not considered to be a complete or exhaustive list.

In one embodiment, the automated cosmetic application system of the present subject matter utilizes computer vision and mechanical actuation to automatically apply cosmetics to a user's face. Indeed, the system is intended to improve the convenience, speed, accuracy, and accessibility of makeup application. The system includes one or more capture devices (e.g. cameras, depth sensors) configured to capture the user's facial features in real time. This data is processed by a facial mapping module that identifies feature locations such as eyes, lips, cheekbones, and jawline, as well as skin tone and texture.

The camera 101 is a high-resolution RGB-D camera that captures both color and depth information. The camera should have a resolution of at least about 1080p to ensure fine details are captured, a frame rate of from about 30 FPS to about 60 FPS to provide tracking of facial movements, and should be mounted in such a manner to provide an optimal angle to capture the entire face of the subject user.

The facial mapping software technology uses AI and AR for real-time facial recognition and mapping, incorporates machine learning algorithms to identify facial features and contours accurately, ensures data privacy and security, processing images locally or in a secure cloud environment, and can be customized to account for different skin tones, textures, and facial structures. The cosmetic application system is configured to generate a fully customizable and user-specific aesthetic output, offering a high degree of adaptability to individual preferences, skin types, facial features, and cosmetic trends. Through the integration of a computer vision system and advanced facial mapping algorithms, the system can capture detailed facial geometry and texture data, enabling the robotic applicator or cosmetic mask to apply makeup with professional grade accuracy.

The cosmetic application system includes a user interface (UI) designed for intuitive user interaction, allowing users to customize, control, and initiate the cosmetic application process. The UI may be delivered through a touchscreen display integrated into the device, a connected mobile or desktop application, or a voice-activated virtual assistant integration. The user interface comprises a graphical user interface (GUI) configured to provide access to the following features: (1) User Profile Management, (2) Look Selection Module, (3) Real-Time Facial Mapping Display, (4) Manual Customization Tools, (5) Preview Mode, and (6) Application Method Selector.

The User Profile Management feature allows users to create, edit, and store personalized profiles containing preferences such as skin tone, style history, cosmetic sensitivities, and favorite looks. In the Look Selection Module, users may select from preconfigured templates (e.g. natural, dramatic, editorial), upload their own makeup designs, or generate new looks through AI-powered suggestions. The Real-Time Facial Mapping Display provides a live or rendered 3D model of the user's face, showing mapped zones (e.g. lips, eyelids, cheeks) with suggested or selected cosmetic overlays. Manual Customization Tools offer the users the ability to modify color palettes, coverage levels, and application intensity of each zone via drag-and-drop, sliders, or gesture inputs. In Preview Mode, a simulated outcome is rendered onto the user's facial map using augmented reality (AR) overlays or previsualization tools before committing to application. With the Application Method Selector, the users may choose between robotic application or generation of a 3D-printable cosmetic mask. The interface adapts to the selected mode accordingly.

In one embodiment, the user interface (UI) can be adapted to support voice commands for hands-free operation and may include accessibility features, such as haptic feedback, high-contrast display modes, and audio prompts, to accommodate users with visual, motor, or cognitive impairments.

One aspect of the cosmetic application system of the present subject matter is its control logic architecture. The control logic is executed by one or more processors that coordinate between the UI, facial mapping system, robotic actuator (if used), and the cosmetic dispensing system. The control logic component can be divided into the following functional layers: an input processing layer, a facial mapping integration layer, a motion and path planning layer, a cosmetic control layer, and a feedback loop and monitoring layer.

The input processing layer captures user input from the UI or sensors, parses selection data, and retrieves corresponding parameters (e.g. desired contoured depth, line thickness, blush placement) from the makeup style templates and/or profiles. The facial mapping integration layer converts facial mapping data into spatial coordinates, normal vectors, and curvature matrices which are used to determine applicator paths or mask zone layouts. Within the motion and path planning layer, application paths are computed using algorithms including inverse kinematics for robotic arm articulation, spline interpolation of smooth motion across facial zones, collision avoidance for facial features and device structure. The cosmetic control layer regulates product dispensing rates, applicator contact pressure, and zone-specific variation (e.g. applying foundation broadly, eyeline with fine control). While the feedback loop and monitoring layer provides real-time image and motion sensors, provide feedback on the applicator's position and user micro-movements. If misalignment is detected, the system can pause, recalibrate, or issue a corrective instruction.

The automated cosmetic application system of the present subject matter further may comprise a cloud-based back end for secure storage of user data and makeup style templates and profiles, updates to cosmetic style templates, synchronization across multiple user devices, data analytics for product improvement, and personalized cosmetic recommendations. The user interface and control logic framework ensures a seamless, personalized, and accessible experience, allowing users of all skill levels and physical abilities to benefit from professional-grade cosmetic application through automation or guided self-use.

The automated system further can adapt its application method based on user-specific factors such as skin tone, texture, and sensitivity. It can dynamically modify application pressure, motion path, and product type to accommodate dry, oil, mature, or combination skin. This adaptability ensures optimal blending, product adherence, and visual harmony. In one embodiment, the robotic application can adjust its stroke direction, speed, and angle in response to the mapped curvature of the user's face, enhancing precision on non-planar surfaces such as eyelids, cheekbones, and around the nose. A processor executes software algorithms to generate a three-dimensional map of the user's face. These algorithms determine the placement, contour, and intensity of cosmetic application based on user preferences, makeup style templates, or real-time environmental adjustments, such as lighting.

The system utilizes an integrated computer vision and facial mapping subsystem to enable a high-precision cosmetic application tailored to the user's unique facial features. This subsystem is composed of one or more imaging sensors, a depth sensor array, and a processing unit executing advanced facial detection and mapping algorithms. The computer vision module includes RBD Cameras (visible light) used for capturing high-resolution images of the user's face to determine surface characteristics, skin tone, and color consistency. Infrared (IR) sensors or Time-of-Flight (ToF) cameras are used for depth sensing and 3D spatial mapping of facial topology. Structured Light Projectors project a known light pattern onto the face to enhance surface detail acquisition in varied lighting environments. The captured data from the sensors is sent to a local or cloud-based processing unit for analysis.

The automated cosmetic application system of the present invention begins by pre-processing image and depth data using techniques such as noise reduction, image normalization for lighting correction, and edge detection to enhance contrast at feature boundaries. Following this pre-processing step, the system executes facial landmark detection using trained convolutional neural networks and shape regression models. Key facial landmarks include, but are not limited to, outer and inner eye corners, nostrils, lip corners, eyebrow arches, cheek contours, jawline, and chin. The algorithm identifies and maps between 60 and 140 landmark points on the user's face, depending on the resolution setting and desired cosmetic precision. Once landmarks are detected, the system constructs a 3D facial mesh using techniques such as triangulated surface modeling, depth interpolation and surface fitting via Bezier surfaces or non-uniform rational B-splines, and point cloud alignment and pose estimation to correct for minor user movements. The resulting facial mesh is used to guide the robotic arm's motion paths or to generate the geometry for a 3D-printed cosmetic mask.

The automated cosmetic application system may employ UV mapping techniques as part of the facial mapping process to enable precise alignment of cosmetic application with the user's unique facial geometry in some embodiments. UV mapping refers to the computational method of projecting a three-dimensional (3D) facial surface model onto a two-dimensional (2D) coordinate system, wherein the coordinates are denoted as U (horizontal axis) and V (vertical axis). This mapping allows complex 3D surface features of the face to be represented in a flattened 2D texture map that can be processed efficiently by the control algorithms. This process is initiated with acquisition of high-resolution facial data using imaging sensors, depth cameras, and/or structured light scanners. This data generates a 3D facial mesh, capturing anatomical features such as contours, bone structure, and skin curvature. The UV mapping algorithm then “unwraps” the 3D mesh into a 2D parameterization, preserving spatial relationships of surface points and aligning them with corresponding texture coordinates. UV mapping enables the software to generate a precise correspondence between intended makeup regions (e.g. eyelids, lips, and cheekbones) and their actual 3D positions of the user's face. The control logic translates cosmetic style templates, stored in 2D texture coordinates, back onto the 3D geometry of the user's face. This ensures accurate robotic arm movement paths, even across complex curved areas such as around the eyes and nose.

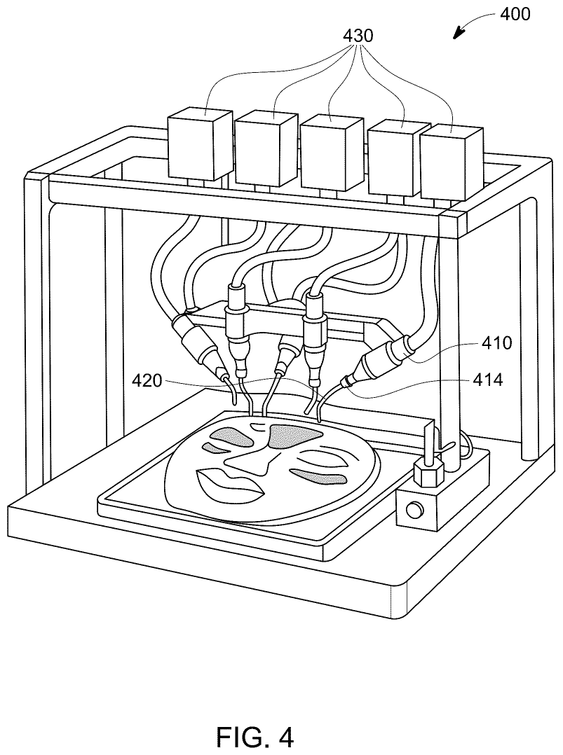

Referring now to FIG. 4, in one embodiment, the automated cosmetic application system of the present subject matter activates a multi-axis robotics component 400 configured with interchangeable cosmetic applicators 410. The robotic arm is controlled by a central processor that receives mapping data and applies selected cosmetic products to a user's face in accordance with pre-defined or user-customized aesthetic style. Real-time safety monitoring is incorporated to pause operation in the event of user movement or discomfort. Voice command input allows for interactive control throughout the process.

The robotic applicator is configured as a multi-axis robotic arm with precise control over movement comprising interchangeable heads including brushes, sponges and airbrush nozzles, actuation by high-precision motors and actuators for smooth and controlled application, force and tactile sensors to adjust pressure and ensure gentle application, and a control system with advanced software for mimicking professional makeup techniques. In some embodiments, the robotic arm may include a robotic hand component. The robotic arm is configured with multiple degrees of freedom including multiple joints to enable movement in three-dimensional space. Attached to the distal end is an interchangeable applicator mechanism 414, capable of receiving various cosmetic tools (e.g. brush heads, sponges, spray nozzles). The robotic applicator includes one or more end-effectors designed to hold and manipulate cosmetic applicators. Applicators may include brushes, sponges, spray nozzles, or cartridges, depending upon the cosmetic product.

The multi-axis nozzles 420 are arranged on an articulated gantry or robotic arm system, enabling movement along X, Y, and Z axes, as well as angular adjustments, such as pitch, yaw, and roll, to ensure accurate deposition over contoured facial regions such as the nose bridge, lips, and orbital areas. The nozzles are configured to vary flow rate and line width to control thickness, blending, and layering of cosmetic compositions.

Cosmetic formulations may include foundations, blushes, contour creams, lip colors, and eyeshadow pastes, each dispensed from a dedicated reservoir connected to one of the plurality of nozzles via controlled pumping mechanisms. It will be understood that the foregoing formulations are presented by way of example only, and that any cosmetic, dermatological, or skincare compositions suitable for transfer and deposition may be employed within the scope of the automated cosmetic application system of the present subject matter. A valve-based catch-and-release system is provided to permit rapid switching between formulations, thereby supporting multi-product applications without requiring nozzle replacement.

The apparatus further incorporates a sensor-guided feedback system using machine vision and/or proximity sensors to verify nozzle position relative to the user's face or to the mask surface in real time. This ensures that the deposited cosmetic aligns precisely with mapped facial zones, maintaining consistency across successive mask production runs. The nozzle system uses primary colors (red, blue, yellow), black and white and can be in the form of cartridges 430 of easy replacement.

In one embodiment, the robotic applicator comprises a robotic arm assembly configured to perform automated cosmetic application tasks with precision and efficiency. The robotic arm assembly includes multiple joints and degrees of freedom, enabling multidirectional movement across the user's facial surface as guided by facial mapping data and application algorithms. The distal end of the robotic arm is equipped with a modular applicator interface, designed to receive and secure a variety of interchangeable cosmetic applicators. Each applicator is configured to the characteristics of a particular cosmetic product type, such as foundation, blush, eyeshadow, eyeliner, lip color, or skincare primer. Applicator types may include, but are not limited to, sponge heads, fine-tip brushes, wide-angle pas, airbrush nozzles, and silicone stampers.

The modular interface of the robotic applicator employs a catch-and-release fastening mechanism that provides for the secure attachment, quick detachment, and automated exchange of cosmetic applicators. The fastening mechanism may include mechanical latching, magnetic coupling, a bayonet mount, or an electromechanical pin system. In particular, the mechanical latching system comprises spring-loaded or servo-driven latches which engage mating features on the applicator based. A retraction or unlocking sequence initiated by the control system allows for the safe release. The magnetic coupling comprises high-strength neodymium magnets which align and hold the applicator in place, with an integrated magnetic sensor confirming securing coupling. The bayonet mount is a twist-lock bayonet connector which ensures secure rotational engagement and quick-release with a partial turn. The electromechanical pin system includes retractable locking pins inserted into slots or holes on the applicator module. Controlled electronically, these pins withdraw during applicator changes. Sensors embedded in the applicator interface RFID, QR, or other optical or digital tags. The control system responds accordingly, adjusting application force, path, speed, and pressure to suit the specific cosmetic product and surface area. An optional automated tool changing station may be positioned within the booth, allowing the robotic arm to dock and swap applicators autonomously without user intervention. The tool station may include cleaning and sanitization modules to prepare applicators between uses or prior to reuse for hygiene compliance. The interchangeable applicator heads of the robotic arm assembly (e.g. brushes, sponges, nozzles) is configured to deposit a specific cosmetic material with variable pressure and coverage. Based on the user profile and mapped data, the system executes a stepwise routine: (1) primer is applied in a sweeping motion, (2) foundation is airbrushed or sponge-applied in gradient layers, and (3) eyeshadow, eyeliner, mascara, blush, and lipstick are applied in precise strokes based on pre-calculated vector paths.

Throughout the cosmetic application process, the computer vision system operates in real time to monitor the robotic applicator's position relative to the face. Using simultaneous locating and mapping or Kalman filtering, the system continuously adjusts for micromovements, ensuring precise alignment and avoiding user discomfort or error.

Head movement is monitored by embedded sensors in the headrest. If flinching or displacement exceeds a threshold, the robotic arm retracts to a safe, standby position, and the system alerts the user. Voice commands, such as “less blush” and “pause” may be used to adjust parameters mid-session. Once the makeup look is complete, the system displays a composite preview and side-by-side view of the applied makeup versus the template. If desired, minor touch-ups can be requested. At the conclusion of the session, the robotic tools are automatically sanitized, and the booth is reset for the next user. This functionality enables the system to deliver a highly tailored and repeatable cosmetic application experience that adjusts to individual facial features, maintains safety, and ensures visual fidelity to the selected make-up look.

More particularly, professional makeup artists will be engaged to assist with training a robotic hand to mimic their makeup application techniques, including the dexterity, pressure, and motion of their movements while applying makeup to a real or mannequin face. This trained robotic hand or apparatus will be used with a software that will include AI and AR facial mapping and digital try-on of preconfigured makeup style templates, skincare product combinations, and combinations thereof. A user is enabled to make adjustment to colors, intensity, and placements of some or all the makeup or skincare components.

In operation, a user will sit in the chair, enable the camera and software to map the user's face (facial mapping), choose a makeup style template, and adjust the look of the makeup style template if desired. The user sits upright in the chair, secures the head stabilizer, and enables the software to begin the cosmetic application process with the robotic hand/apparatus. Alternately, the user will select the option which enables the software to 3D print the selected preconfigured look onto a makeup transfer sheet mask. In certain embodiments, rather than offer a makeup style look or transfer mask, the automated cosmetic application system can be used to apply skin care and other dermatological products and/or perform dermatological treatments.

Once the user selects the desired look to be applied to the face or printed to a mask, the makeup must be mixed in such a manner that the colors chosen in the digital, on-screen appearance is precisely applied to the user's face.

Additional technical considerations for the automated cosmetic application system of the present subject matter include (1) seamless integration of all components with a central control unit, (2) a reliable power source with backup options, (3) regular software updates to improve functionality and add new features, (4) user safety considerations to ensure that all moving parts have safety mechanisms to prevent injury, and (5) ergonomically designed for comfort and ease of use, accommodating various body sizes and postures. The system may be equipped with safety features including proximity sensors, pressure controls, and emergency stop mechanisms. It also may include self-cleaning routines for applicators and maintain hygiene by using disposable tips or covers.

Developing the automated cosmetic application system involves several technical, logistical, and user experience challenges. Discussed hereinbelow are some key development challenges and strategies with which they can be addressed.

To ensure that facial mapping software accurately identifies and adapts to diverse facial features, skin tones, and textures, it is key to develop and train machine learning models on a diverse dataset to improve accuracy and inclusivity, as well as the regular update the software with new data to refine its capabilities.

Both application modalities are supported by a user interface that allows for the selection, refinement, storage, and re-use of aesthetic profiles. These features allow the system to evolve alongside the user's preferences and maintain consistent results over time. The automated cosmetic application thus is well-suited for personal, commercial, or clinical settings where time efficiency, accessibility, and hygiene are critical. Accordingly, the system provides a versatile and innovative cosmetic application system that combines robotic automation, additive manufacturing, and facial recognition to deliver a highly personalized, efficient, and user-friendly experience.

For user-specific operation, the system utilizes biometric identification for seamless personalization with enhanced security and convenience. A key benefit of biometric identification for user specific operation is seamless personalization with enhanced security and convenience. The use of facial recognition, for example, allows the system to automatically recognize the user upon approach, retrieve their saved preferences, and load past cosmetic styles, skin sensitivity settings, custom application zones, and chosen application methods (robotic or 3D mask). This feature eliminates the need for repeated manual logins or makeup template selections, making the process faster and more user-friendly. Users with limited dexterity or time constraints will confirm that such a feature is especially important. Such techniques may include: Eigneface or Fisherface analysis for identify verification, Local Binary Pattern Histograms (LBPH) for low-resource facial recognition, Deep neural networks for robust, multi-angle recognition. Upon user verification, stored preference profiles, previous applications, and cosmetic selections are retrieved and linked to the current facial mapping to ensure consistency across cosmetic application settings.

As with the robotic arm embodiment, the user undergoes 3D facial scanning within the booth or through a remote mobile application. This facial landmark data is used to generate a custom mask geometry that aligns precisely with facial contours and key features (e.g. eyes, lips, cheekbones). Using the user's profile and desired aesthetic, a print layout is generated in which the designated pigmented zones are embedded into the inner surface of the mask corresponding to the application areas.

After facial imaging is completed, the system generates a 3D digital model of the user's face. The printed mask is generated to match both the topography and cosmetic pattern aligned with the user's chosen aesthetic. The logic exports mapped zone data and cosmetic patterns to a print-ready digital file (e.g. STL or OBJ format), with embedded regions containing color-coded or texture-filled cosmetic materials. Cosmetics are deposited into specific facial zones of the mask, ensuring a one-step transfer of the selected makeup template or modified makeup template. This model is used to design a cosmetic mask, which is 3D-printed using flexible, skin-safe material. During the printing process, cosmetic formulations are deposited in designated areas on the inner surface of the mask. Once printed, the mask is aligned with the user's face and gently pressed onto the skin, transferring the cosmetics in the mapped pattern onto the user's skin. Together, these features allow the system to deliver an aesthetic output that not only is artistically consistent, but also tailored to the user's facial structure, preferences, and real-world conditions, enabling a highly personalized and repeatable beauty application. This embodiment offers a simplified application experience and can be used in scenarios where direct robotic application is impractical or undesired. The mask version of the automated cosmetic application system of the present subject matter can be customized for the user's face using and printed using the 3D printer.

In certain embodiments, each mask can be applied in multiple pieces or sections for different areas of the face (for example: eyelids and above, under eyes to chin, neck), pressed firmly onto the specific facial area, and then peeled off to transfer the makeup to the face. This process may be performed with or without the use of a separate device, substance, or other activator.

Users may select from a range of cosmetic styles, examples of which include, but are not limited to natural, glam, evening, editorial, theatrical, holiday-inspired, sport-team color templates, or custom event-specific looks, through an interactive user interface. In addition, the system allows users to define individual preferences including coverage intensity, color palette, finish (e.g. matte, dewey, shimmer), and highlight or contour placement. These preferences may be stored in the user's profile for future retrieval or iterative enhancement, allowing consistent recreation of favored looks or seamless experimentation with new styles.

In one embodiment, the system comprises a remapping reminder module configure to prompt the user to undergo an updated facial mapping procedure after a predefined time interval has elapsed since the initial mapping and production of the rigid outer shell. The system a non-transitory memory or user profile database storing the date and version of the identifier of the most recent facial mapping used to generate the rigid outer shell. The system also may track frequency of use, duration since last remapping, and any changes in cosmetic alignment performance reported by the user. A time-based reminder mechanism is initiated at the time the user first completes a full facial mapping and confirms the creation or use of a rigid outer shell. After a configurable time threshold (e.g. six (6) months), the system is programmed to display a remap recommendation notification via the user interface. The reminder may be presented through visual prompt on the device's graphical user interface (GUI), push notification to a companion mobile application, email, or SMS alert, where the user has opted-in to such services, or voice assistant cue if the system supports speech synthesis. The message may include language such as “it has six months since your last facial mapping. For optimal alignment and cosmetic results, we recommend updating your facial profile and evaluating your current shell fit. Would you like to schedule a remap now?”

In addition to time-based reminders, the system optionally may prompt a remap based on user feedback (e.g. repeated reports of misalignment), biometric deviation detection, where periodic facial scans suggest significant changes in facial geometry beyond a defined threshold, device performance logs, such as repeated mask repositioning, or poor adherence in the transfer process. Users may configure the reminder interval, opt-out of notifications, or initiate a remap at any time via the system interface. The system also may allow reminders to be postponed or snoozed for a selected period. This feature ensures long-term accuracy, preserves user satisfaction, and encourages continued engagement with the system.

This embodiment provides consistent placement and precision of cosmetic elements due to fixed facial alignment, low-effort application for individuals with motor disabilities, reduced variability in outcome for users with limited cosmetic experience, more hygienic operation, as the inner mask is single-use and the rigid shell can be sanitized easily, and customization and adaptability, as multiple inner masks including specific makeup styles, can be used with the same personalized outer shell.

To ensure the precision of the robotic application to achieve the precision and gentleness required to mimic professional makeup application techniques, utilization of high-precision motors and actuators in the robotic arm, incorporate force and tactile sensors, as well as conducting extensive testing and iterative improvements to refine the application process.

The challenge of maintaining hygiene of the tools and ensuring user safety will be met by implementation of robust UV-C sterilization systems with safety locks to prevent accidental exposure. Use skin-safe materials and design all moving parts with safety mechanisms to prevent injuries.

The automated cosmetic makeup system of the present subject matter is operable via a touchscreen, voice recognition module, or mobile application. Users may select from pre-programmed makeup looks, customize their own application preferences, or use adaptive features based on prior usage history. Designing an intuitive user interface that allows users to easily select and customize makeup looks by creating and developing a user-friendly touchscreen interface with clear instructions and visual aids. Providing customization options and preview features assist users to visualize their selected looks. Designing an intuitive user interface that allows users to easily select and customize makeup looks by creating and developing a user-friendly touchscreen interface with clear instructions and visual aids.

All hardware and software components must be seamlessly integrated to work together harmoniously. Therefore, it is key to develop a central control system that coordinates all components, ensuring real-time communication and synchronization. Conducting thorough testing to identify and resolve integration issues is a key factor in the success of the glam pod/glam mask.

To ensure that the 3D-printed makeup masks fit perfectly and transfer makeup accurately, the use of high-resolution 3D printers with skin-safe materials, optimization of the printing process for speed and accuracy and implementation of quality control measures to ensure each mask meets the required standards is paramount.

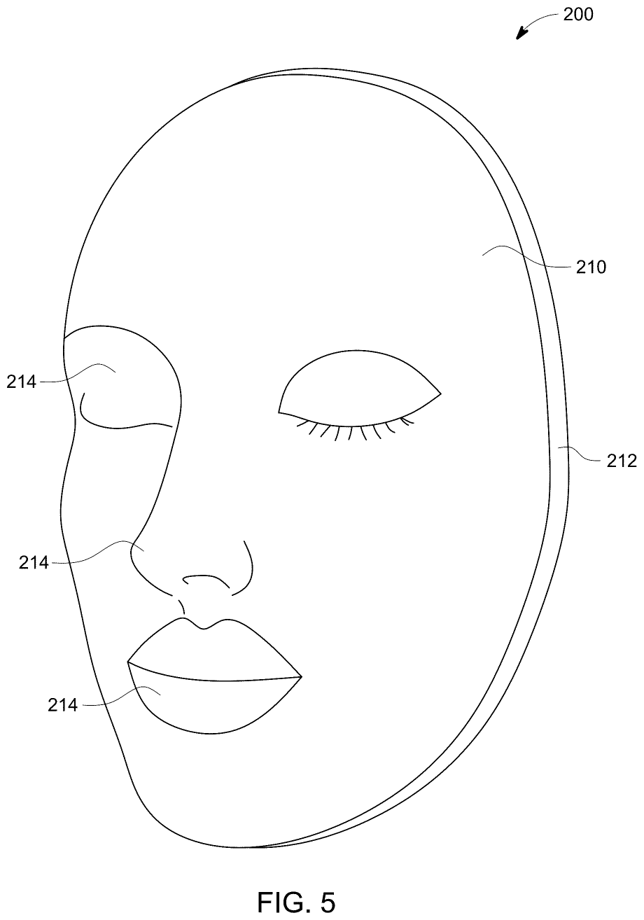

In one embodiment custom 3D-printed masks can be generated by the application system if the user selects a mask option. The personalized custom 3D-printed cosmetic application transfer mask utilizes additive manufacturing. Referring now to FIG. 5, based on the facial mapping data, a single layer formed mask having a rigid outer shell is digitally modeled and fabricated via the 3D-printing process to conform precisely to the contours of a user's face. The outer shell ensures precise placement for consistent and hygienic transfer of facial makeup. In this manner, the user may apply the mask when desired, transferring the facial makeup from the interior side of the outer shell of the mask to the user's face.

More particularly, the automated cosmetic application system is a direct-to-consumer cosmetic application transfer mask 200 comprises a rigid outer shell surface 210, as shown in FIG. 5 and an inner surface 220 defining an interior concave cavity 222 shaped to match the three-dimensional geometry of the user's face. More particularly, the outer shell of the cosmetic mask preferably is fabricated from a lightweight, skin-safe thermoplastic resin or polymeric composite material using additive manufacturing. The outer shell further comprises a peripheral edge 212 and one or more alignment guides and indexing features 214, such as nose bridges, chin cups, or orbital impressions, to ensure accurate placement, and ventilation apertures or breathability channels near the nose and mouth areas for user comfort during application. Optionally, attachment points of hinge elements are provided on the outer shell to support a mounting frame or storage dock.

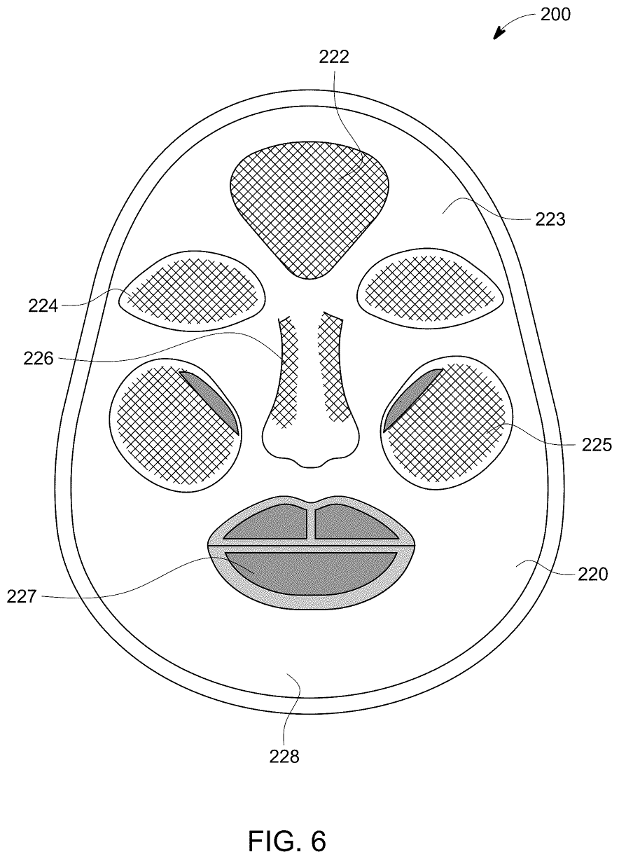

The inner surface 220 of the outer mask 200 is composed of a flexible substrate material having pre-applied cosmetic formulations, such as foundation, blush, eyeshadow, eyeliner, and lip color, disposed thereon in accordance with the mapped facial landmarks 221. In FIG. 6, these facial landmarks include a forehead area 222, a facial base area 223, an ocular area 224, a cheek area 225, a nose area 226, a lip area 227, and a chin area 228. However, it will be understood that these facial landmarks are exemplary and different facial landmarks are contemplated to be within the scope of the present invention. To apply the makeup onto the user's face, the user aligns the rigid shell onto the face using the integrated alignment guides 214 and gently applies pressure to the outer surface of the rigid outer shell which presses the pre-applied cosmetic formulation disposed on the interior concave cavity onto the user's face. Pressure can be applied manually or by means of docking station. After a dwell period, for example between about 5 seconds to about 60 seconds, the pigments on the interior concave cavity are adhered to the skin by pressure or by thermal activation. The user then removes and disposes of this single-use 3D cosmetic application transfer mask.

In one embodiment, a cosmetic application transfer mask is produced using a 3D printer system with a soft, flexible biocompatible polymer, suitable examples of which include, but are not limited to silicone and thermoplastic polyurethane (TPU), layered with cosmetic links and powders. Regions of the mask are pre-treated with heat-activated or pressure-sensitive pigment transfer layers. In one embodiment, an alignment guide such as a nose ridge or cheek cutouts, can be provided to ensure correct placement. The user may receive the custom mask immediately (on-site), or a later time. To apply the look, the user aligns and presses the mask gently onto the face. The system may include a short-duration warming or ultrasonic mechanism to activate the transfer. After a preset time (e.g. 5-60 seconds), the user peels away the mask to reveal the transferred makeup onto the facial skin. Any minor areas requiring blending or smoothing may be completed manually or with a handheld smart applicator. The mask is disposable and can be packaged for travel. Optional embedded sensors (e.g. QR-coded patterns) allow the system to record the outcome and adjust future iterations.

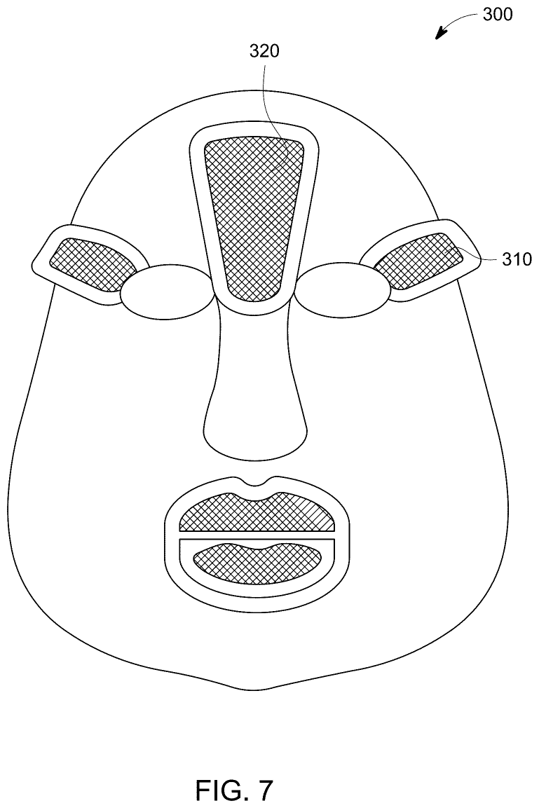

In one embodiment shown in FIG. 7, a cosmetic application transfer mask 300 having perforated eye enclosures 310, and optionally a nose bridge enclosure 320, is formed as a single-layer, 2D cosmetic application transfer mask. The enclosures are strengthened by micro-hinge structures or dual-layer perforation patterns that allow the flap to detach smoothly along the intended boundary without tearing into adjacent cosmetic regions. The enclosures, sometimes referred to as flaps, may be folded back and temporarily adhered to the mask exterior by low-tack adhesive or hook-and-loop micro-fasteners, to prevent interference during subsequent cosmetic stages. The inner surface of the flaps may be provided with a removable protective layer.

The cosmetic mask 300 comprises a flat, flexible sheet configured to conform to the contours of a user's face for the application of cosmetic products. The mask further comprises reinforced perforated eye enclosures 310 which are designed to be selectively opened in stages to permit multistage cosmetic application, such as sequentially applying foundation, eyeshadow, and eyeliner within a single mask session. To address alignment challenges, the application transfer mask 300 further comprise a perforated nose bridge flap 320. The mask 300 optionally may include integrated alignment guides such as adhesive anchor points or contoured shaping along the nose bridge, cheekbones, or jawline, to ensure consistent and secure positioning on the user's face. These alignment guides reduce the risk of slippage and improve precision across the different face shapes. The perforated eye enclosures 310 are strengthened by micro-hinge structures or dual-layer perforation patterns that allow the flap to detach smoothly along the intended boundary without tearing into adjacent cosmetic regions. The flaps may be folded back and temporarily adhered to the mask exterior by low-tack adhesive or hook-and-loop micro-fasteners, to prevent interference during subsequent cosmetic stages.

To improve cosmetic transfer, the inner surface of the mask may be treated with a transfer-optimized coating or micro-texturing designed to release pigments and formulations evenly onto the skin while accommodating variations in skin type. In addition, the material may comprise a breathable polymer blend to enhance adhesion and comfort during wear. To ensure that each mask is sanitized, each mask may be individually packaged in sterile conditions and offered as a single-use article, while the design minimizes waste by utilizing thin yet durable polymers. This cosmetic mask configuration allows the flexible sheet mask to achieve greater accuracy, hygiene, and usability, while still enabling multistage cosmetic application through its selectively operable perforated eye enclosures.

The 2D printed cosmetic application transfer mask is generated to match both the topography and cosmetic pattern aligned with the user's chosen aesthetic. Cosmetics are deposited into specific facial zones of the mask, ensuring a one-step transfer of the selected look upon application. Together, these features allow the system to deliver an aesthetic output that not only is artistically consistent, but also tailored to the user's facial structure, preferences, and real-world conditions, thereby enabling a highly personalized and repeatable beauty application.

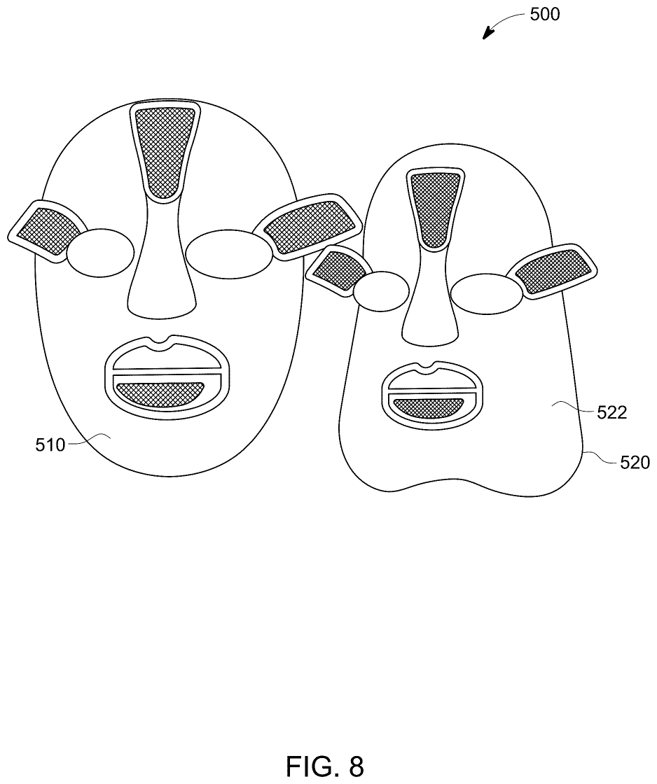

In one embodiment shown in FIG. 8, the automated cosmetic application system comprises a dual-layer cosmetic application transfer mask 500 configured to optimize structural alignment, cosmetic transfer precision, and hygiene. The dual-layer mask comprises a 3D outer formed mask 510 and a 2D inner formed mask 520, wherein the two masks are used in combination to prepare and deliver cosmetics to a user's face. The outer formed mask is fabricated from a substantially rigid material shaped according to the three-dimensional geometry of a user's facial mapping data. The outer mask 510 functions as a structural support and alignment frame, ensuring dimensional stability and accurate positioning of the mask assembly relative to the user's face. The outer mask may further comprise retaining features such as guide channels, clips, or recesses for receiving and securing the inner mask in proper orientation. The inner mask 520 is a flat, two-dimensional mask having a substrate surface 522 for receiving the cosmetic formulation. The inner mask may be aligned with the outer mask using adhesive strips or with magnetic alignment fasteners. The magnetic alignment fasteners of the inner mask may include embedded magnetic particles that couple with corresponding magnetic elements in the outer mask.

The inner formed mask 520 is fabricated from a material that is slightly less rigid than the outer mask, thereby providing a limited degree of flexibility while maintaining overall conformance to the mapped facial geometry. The inner formed mask is intended for single-use application and is configured to be placed inside the outer mask prior to cosmetic deposition. Once positioned onto the user's face, the substrate surface contacts the face and transfers the cosmetic formulations.

To facilitate multi-stage cosmetic application, the inner mask further comprises hinged eye flaps formed along controlled perforation lines. Each flap may an inner surface containing a cosmetic formulation which is protected with a removable protective layer. These flaps remain open during the initial stage of cosmetic deposition, allowing foundation, primer, contour, and/or blush to be applied without affecting the eye regions. At a subsequent stage, the eye flaps may be selectively closed and pressed against the designated eye zones, thereby permitting application of eye shadow, eyeliner, and/or other eye-related cosmetics while maintain precise alignment. The hinged configuration ensures that the flaps detach or pivot smoothly along predetermined boundaries, minimizing the risk of tearing or misalignment.

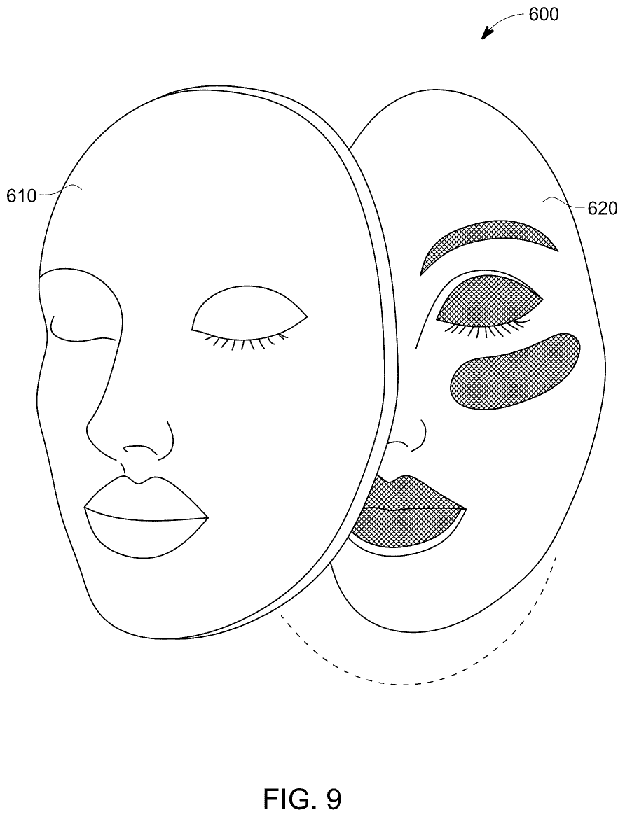

In one embodiment, shown in FIG. 9, the automated cosmetic application system comprises a dual-layer cosmetic application transfer mask 600 configured to optimize structural alignment, cosmetic transfer precision, and hygiene. The dual-layer mask comprises a 3D outer formed mask 610 and a 3D inner formed mask 620, wherein the two masks are used in combination to prepare and deliver cosmetics to a user's face in the manner described with reference to cosmetic application transfer mask 600.

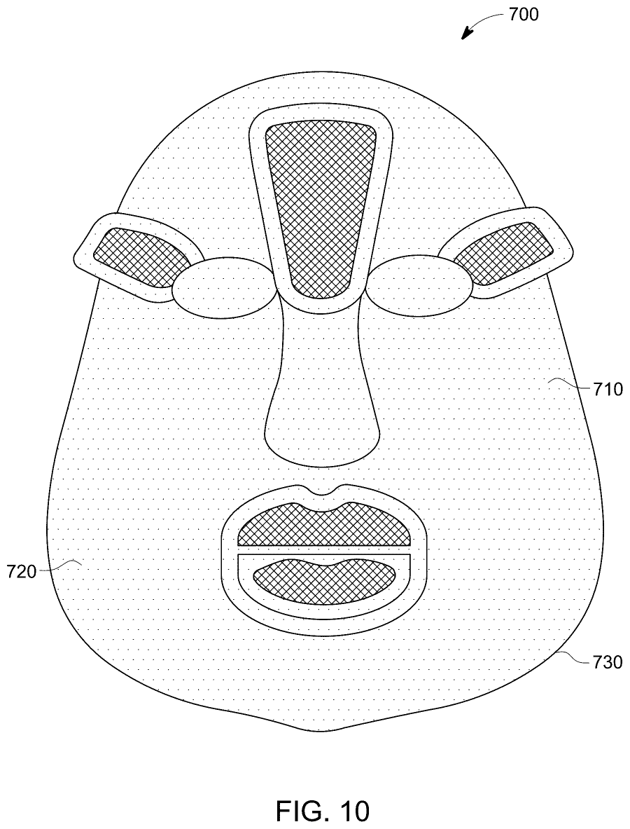

In one embodiment shown in FIG. 10, a direct-to-consumer moisture activated cosmetic application transfer mask 700 is provided, which utilizes a moisture activated mechanism having a multi-layer construction having a layer 710 in which the cosmetic pigments are disposed on a silicone transfer layer 720 backed by a porous substrate 730. The porous substrate is engineered with defined pore diameters and open-cell architecture to facilitate directional moisture transport via capillary action. During use, water is sprayed onto and penetrates the outer surface of the porous substrate. The absorbed moisture migrates through the porous substrate towards the silicone layer, initiating a controlled reduction in interfacial adhesion between the silicone and the cosmetic pigment layer. This reduction in adhesion is achieved without direct hydration of the skin-facing side of the transfer layer, allowing the pigment layer to evenly separate from the silicone layer and stay uniformly onto the skin.

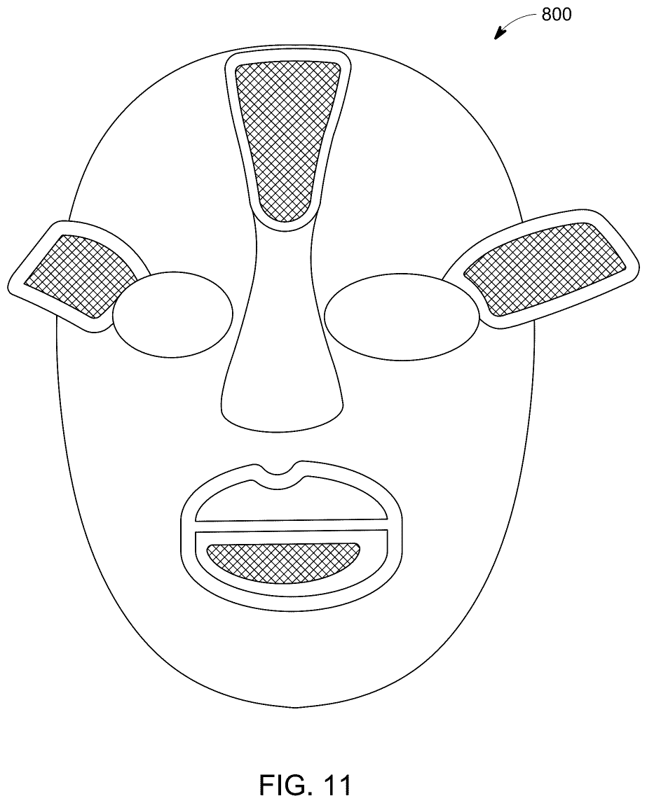

In one embodiment, the automated cosmetic application system comprises a single-layer 3D cosmetic application transfer mask 800 designed to conform to the three-dimensional geometry of the user's face as determined by facial mapping data. Referring now to FIG. 11, the formed mask includes integrated hinged eye flaps positioned over the eye regions. The eye flaps are defined by controlled perforation lines, thinning regions, or hinge-like features that allow the flaps to remain closed during the initial stage of cosmetic application and subsequently opened or displaced for secondary cosmetic application. In operation, when the eye flaps are closed, the system may deposit foundation, blush, primer, or other base cosmetics without interference with the ocular region. Thereafter, the eye flaps may be opened to expose the eye zones for precise application of eyeshadow, eyeliner, or related eye products, ensuring that the overall cosmetic look is applied in a controlled, multi-stage process.

The hinged eye flap feature is not limited to the single-layer mask. Rather, the hinged eye flap feature may be incorporated into any of the mask embodiments described herein. In this manner, the hinged eye flap design provides versatility across multiple configurations of the invention, enabled staged cosmetic application with improved precision and expanded aesthetic options.

In operation, a cosmetic formulation is applied directly onto the surface of an inner-formed mask, either through automated multi-axis deposition nozzles or preloaded manufacturing techniques. The inner mask, now containing the selected cosmetic patterns, then is positioned again the user's face by way of the rigid alignment provided by the outer-formed mask. Transfer of the cosmetic formulations occurs upon contact, thereby ensuring that the cosmetics accurately are delivered to the intended facial regions in accordance with the mapped geometry.

In one embodiment, a cosmetic depositing apparatus is provided for applying cosmetic formulations onto a semi-rigid, formed facial mask generated according to a user's unique facial mapping data. The apparatus comprises a plurality of multi-axis deposition nozzles, each configured to dispense cream-like cosmetic materials with high precision onto predetermined regions of a semi-rigid mask surface. The depositing apparatus receives the mask via a fixture or holding assembly that maintains positional accuracy during application.

In one embodiment, the system comprises a remapping reminder module configure to prompt the user to undergo an updated facial mapping procedure after a predefined time interval has elapsed since the initial mapping and production of the rigid outer shell. The system a non-transitory memory or user profile database storing the date and version of the identifier of the most recent facial mapping used to generate the rigid outer shell. The system also may track frequency of use, duration since last remapping, and any changes in cosmetic alignment performance reported by the user. A time-based reminder mechanism is initiated at the time the user first completes a full facial mapping and confirms the creation or use of a rigid outer shell. After a configurable time threshold (e.g. six (6) months), the system is programmed to display a remap recommendation notification via the user interface. The reminder may be presented through visual prompt on the device's graphical user interface (GUI), push notification to a companion mobile application, email, or SMS alert, where the user has opted-in to such services, or voice assistant cue if the system supports speech synthesis. The message may include language such as “it has six months since your last facial mapping. For optimal alignment and cosmetic results, we recommend updating your facial profile and evaluating your current shell fit. Would you like to schedule a remap now?”

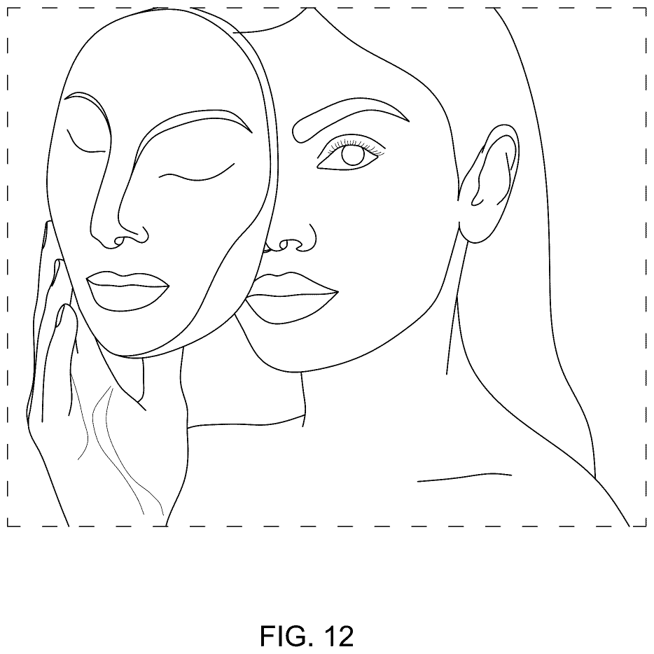

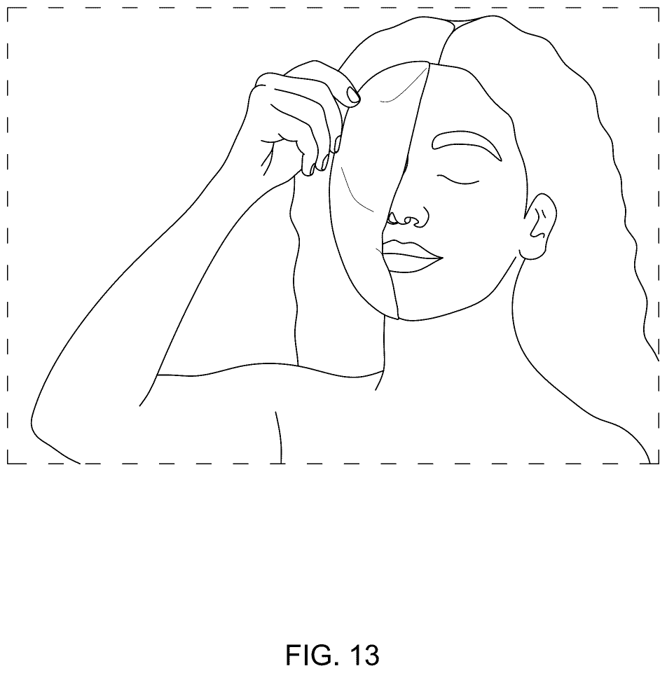

FIG. 12 demonstrates the placement of the cosmetic application transfer mask onto the user's face and FIG. 13 demonstrates the ease removal of the transfer mask.

In addition to time-based reminders, the system optionally may prompt a remap based on user feedback (e.g. repeated reports of misalignment), biometric deviation detection, where periodic facial scans suggest significant changes in facial geometry beyond a defined threshold, device performance logs, such as repeated mask repositioning, or poor adherence in the transfer process. Users may configure the reminder interval, opt-out of notifications, or initiate a remap at any time via the system interface. The system also may allow reminders to be postponed or snoozed for a selected period. This feature ensures long-term accuracy, preserves user satisfaction, and encourages continued engagement with the system.

This embodiment provides consistent placement and precision of cosmetic elements due to fixed facial alignment, low-effort application for individuals with motor disabilities, reduced variability in outcome for users with limited cosmetic experience, more hygienic operation, as the inner mask is single-use and the rigid shell can be sanitized easily, and customization and adaptability, as multiple inner masks including specific makeup styles, can be used with the same personalized outer shell.

To ensure the precision of the robotic application to achieve the precision and gentleness required to mimic professional makeup application techniques, utilization of high-precision motors and actuators in the robotic arm, incorporate force and tactile sensors, as well as conducting extensive testing and iterative improvements to refine the application process.

The challenge of maintaining hygiene of the tools and ensuring user safety will be met by implementation of robust UV-C sterilization systems with safety locks to prevent accidental exposure. Use skin-safe materials and design all moving parts with safety mechanisms to prevent injuries.

The automated cosmetic makeup system of the present subject matter is operable via a touchscreen, voice recognition module, or mobile application. Users may select from pre-programmed makeup looks, customize their own application preferences, or use adaptive features based on prior usage history. Designing an intuitive user interface that allows users to easily select and customize makeup looks by creating and developing a user-friendly touchscreen interface with clear instructions and visual aids. Providing customization options and preview features assist users to visualize their selected looks. Designing an intuitive user interface that allows users to easily select and customize makeup looks by creating and developing a user-friendly touchscreen interface with clear instructions and visual aids.

All hardware and software components must be seamlessly integrated to work together harmoniously. Therefore, it is key to develop a central control system that coordinates all components, ensuring real-time communication and synchronization. Conducting thorough testing to identify and resolve integration issues is a key factor in the success of the glam pod/glam mask.

To ensure that the 3D-printed makeup masks fit perfectly and transfer makeup accurately, the use of high-resolution 3D printers with skin-safe materials, optimization of the printing process for speed and accuracy and implementation of quality control measures to ensure each mask meets the required standards is paramount.

Moreover, to ensure that users can effectively operate the system and troubleshoot common issues, providing comprehensive user manuals, video tutorials, and in-app guidance, as well as offering customer support services, including a helpdesk and online resources will be standard practice.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes, and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption.

The computing system may include an input subsystem that receives user input. The input subsystem may be configured to connect to and receive input from devices such as a mouse, keyboard. or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. An automated cosmetic application system which utilizes artificial intelligence (AI), augmented reality (AR), computer vision including at least one capture device configured to capture a user's facial landmark data in real time, and a facial mapping module that processes said facial landmark data into a three-dimensional image of the user's facial features and contours, said automated cosmetic application system further comprising a robotics component trained to mimic makeup artist techniques of facial cosmetic makeup application, said robotics component including a robotic applicator to apply a selected facial cosmetic makeup style to a user's face, and 3D printing system to generate a cosmetic application transfer masks based on said three-dimensional image.

2. The automated cosmetic application system in accordance with claim 1, adapted to be housed in an application station, said station being an enclosed station, a semi-enclosed station, or open station.

3. The automated cosmetic application system in accordance with claim 1, wherein said application station comprises an ergonomically adjustable chair having a padded and adjustable backrest with contoured lumbar support, and a contoured, adjustable headrest support assembly attached to said chair.

4. The automated cosmetic application system in accordance with claim 1, wherein headrest support assembly further comprises integrated or proximity sensors configured to detect unintentional movement or displacement beyond a predetermined tolerance, and wherein when movement is detected beyond a predetermined tolerance, said automated cosmetic application system will pause said robotic applicator.

5. The automated cosmetic application system in accordance with claim 1, wherein said computer vision includes a high-resolution RGB-D camera, having a resolution of at least about 1080p to ensure fine details are captured, a frame rate of from about 30 FPS to about 60 FPS to provide tracking of facial movements, said camera being mounted to provide an optimal angle to capture the entire face of the user.

6. The automated cosmetic application system in accordance with claim 1, further comprising a user interface (UI) adapted for intuitive user interaction, enabling a user to customize, control, and initiate a cosmetic application process.

7. The automated cosmetic application system in accordance with claim 6, wherein said UI is configured to be deliverable through a touchscreen display integrated with said application system, to a connected mobile or desktop application, and to a voice-activated virtual assistant integration.

8. The automated cosmetic application system in accordance with claim 6, wherein said user interface comprises a graphical user interface configured to provide access to a user profile management, a makeup style template, real-time mapping display, manual customization tools, and an application method selector.

9. The automated cosmetic application system in accordance with claim 6, further comprising a control logic architecture, said control logic architecture being executed by one or more processors that coordinate between the user interface, facial mapping system, a robotic component, and a cosmetic dispensing system.

10. The automated cosmetic application system in accordance with claim 1, further comprising a cloud-based back end for secure storge of user data, makeup style templates, user profiles, updates to cosmetic style templates, synchronization across multiple user devices, data analytics for product improvement, and user personalized cosmetic recommendations.

11. The automated cosmetic application system in accordance with claim 6, which can be configured to adapt the cosmetic application based on user-specific factors selected from the group consisting of skin tone, texture, and sensitivity, and which can dynamically modify application pressure, motion path, and cosmetic product type to accommodate dry, oily, mature, or combination skin, thereby ensuring optimal blending, product adherence, and visual harmony to the makeup style applied to the face of the user.

12. The automated cosmetic application system in accordance with claim 6, which utilizes UV mapping techniques as part of the facial mapping process to ensure precise alignment of cosmetic application with the user's unique facial geometry.

13. The automated cosmetic application system in accordance with claim 1, wherein said robotic applicator is configured as a multi-axis robotic arm having precise control over movement and comprising interchangeable heads selected from the group consisting of brushes, sponges, spray nozzles, and airbrush nozzles.

14. The automated cosmetic application system in accordance with claim 13, wherein said multi-axis robotic arm includes a plurality of multi-axis nozzles, enabling movement along X, Y and Z axes and angular adjustment movement to ensure accurate deposition of cosmetics over contoured facial regions of the user's face.

15. The automated cosmetic application system in accordance with claim 1, wherein said 3D printing system is configured to generate a cosmetic application transfer mask based on said three-dimensional image utilizing additive manufacturing.

16. The automated cosmetic application system in accordance with claim 15, wherein said cosmetic application transfer mask comprises a 3D rigid outer shell having an outer surface and an inner surface, the inner surface having a cosmetic formulation deposited thereon.

17. The automated cosmetic application system in accordance with claim 15, wherein said cosmetic application transfer mask is in the form of a single-layer, 2D flat, flexible sheet configured to conform to the contours of a user's face for the application of cosmetic products and having perforated and hinged flaps in the ocular area of the mask.

18. The automated cosmetic application system in accordance with claim 15, wherein said cosmetic application transfer mask is a dual-layer transfer mask having a 3D outer layer and a 2D inner layer, said inner layer having the cosmetics deposited thereon.

19. The automated cosmetic application system in accordance with claim 15, wherein said cosmetic application transfer mask is a single-layer moisture-activated mask.

20. The automated cosmetic application system in accordance with claim 15, wherein said cosmetic application transfer mask is a 3D single-layer, semi-rigid custom mask having eye-area perforated flaps.
